(19) United States
(12) Patent Application Publication
(10) Pub. No.: US 2015/0166357 A1
(43) Pub. Date: Jun. 18, 2015

(54) Prevention of Theft and Misuse of Ammonia Storage Systems

(71) Applicant: Cummins Inc., Columbus, IN (US)

(72) Inventors: Aleksey Yezerets, Columbus, IN (US); Neal W. Currier, Columbus, IN (US)

(73) Assignee: Cummins Inc., Columbus, IN (US)

(21) Appl. No.: 14/104,657

(22) Filed: Dec. 12, 2013

(51) Int. Cl. C01C 1/00; G08B 13/00

(52) U.S. Cl. CPC C01C 1/006; G08B 13/00

(57) ABSTRACT

A method and system that protects contained anhydrous ammonia, such as from theft or misuse. The contained anhydrous ammonia, for example is part of an ammonia storage and delivery system. The anhydrous ammonia is contained by its absorption into a solid absorbent material. A component is configured to interfere with unauthorized handling of the anhydrous ammonia, where the component is operatively engaged with the contained anhydrous ammonia.

### FIELD

This disclosure relates generally to protection of ammonia storage system, such as from theft or misuse. More particularly, the disclosure herein relates to various implementations and methods that can protect an ammonia storage systems or containers.

### BACKGROUND

Aqueous urea solutions have commonly been used in treatment of diesel exhaust emissions, such as for example in a process known as selective catalytic reduction (SCR). For example AdBlue®, which is a registered trademark for AUS32 (aqueous urea solution 32.5%) or diesel exhaust fluid (DEF), has been used in combination with a catalyst to reduce emissions of oxides of nitrogen (NO_{X}) from the exhaust of diesel engine motor vehicles.

Some challenges to using aqueous urea solution have been that its vaporization and transformation to ammonia requires certain exhaust gas temperatures, which may not be achieved without additional thermal management in certain driving cycles, e.g. during urban driving. There may also be freezing issues for the urea solution and exhaust designs may need more complicated spray patterns and mixers.

Ammonia storage devices have been evolving and attractive alternatives to aqueous urea solutions have been or are being developed. For instance, systems that employ direct ammonia dosing are increasingly becoming viable, such as for example as an alternative to aqueous urea dosing. These systems can produce pure anhydrous ammonia (NH₃). However, such systems which can produce pure anhydrous NH₃ may be attractive to people seeking a source of ammonia for illicit uses, such as for example clandestine synthesis of methamphetamine. By comparison, ammonia derived from a urea solution contains other species, such as water and carbon dioxide, which render it unusable e.g. for the above illicit purpose.

### SUMMARY

Improvements may be made upon such direct ammonia dosing systems so that they may be protected from theft and/or illicit use. Generally, contained anhydrous ammonia, such as may be contained for example in an ammonia storage and delivery system, is described herein such that it is protected from unauthorized handling, including for example theft and/or illicit use. Protection may be achieved through one or more of a component that employs a chemical, mechanical, and/or electronic way of protecting the contained anhydrous ammonia from unauthorized handling.

A method and system are described that protects contained anhydrous ammonia from unauthorized handling. The anhydrous ammonia is contained by its absorption into a solid absorbent material. A component configured to interfere with unauthorized handling of the anhydrous ammonia, is operatively engaged with the contained anhydrous ammonia.

In one embodiment, a method of tamper protection of a contained form of anhydrous ammonia comprises introducing a component configured to interfere with unauthorized handling of contained anhydrous ammonia that is absorbed into a solid absorbent material. The component is operatively engaged with the contained anhydrous ammonia. Through operative engagement of the anhydrous ammonia with the component, the contained anhydrous ammonia is protected from unauthorized handling.

In one embodiment according to any of the above, the step of introducing the component includes adding a chemical to the anhydrous ammonia. The component can for example comprise a chemical that, when added to the anhydrous ammonia, interferes with use of the anhydrous ammonia in synthesizing methamphetamine. The component can also for example comprise a chemical, that when added to the anhydrous ammonia, results in a final product that is mal-odorous and/or pungent.

In one embodiment according to any of the above, the component comprises a mechanical device configured to interfere with removal and/or breach of the contained anhydrous ammonia.

In another embodiment according to any of the above, the component comprises an electronic device configured to interfere with removal and/or breach of the contained anhydrous ammonia. The electronic device can for example comprise an alarm system. The electronic device can also for example comprise a tracking system.

In one embodiment, a system that protects a contained form of anhydrous ammonia from unauthorized handling comprises a solid absorbent material and anhydrous ammonia contained by its absorption into the solid absorbent material. A component configured to interfere with unauthorized handling of the anhydrous ammonia is operatively engaged with the contained anhydrous ammonia.

In one embodiment according to any of the above, the component can for example comprise a chemical that can be added to the anhydrous ammonia. The component can comprise a chemical that, when added to the anhydrous ammonia, interferes with use of the anhydrous ammonia in synthesizing methamphetamine. The component can also for example comprise a chemical that, when added to the anhydrous ammonia, results in a final product that is mal-odorous and/or pungent.

In one embodiment according to any of the above, the component comprises a mechanical device configured to interfere with removal and/or breach of the contained anhydrous ammonia.

In another embodiment according to any of the above, the component comprises an electronic device configured to interfere with removal and/or breach of the contained anhydrous ammonia. The electronic device can for example comprise an alarm system. The electronic device can also for example comprise a tracking system.

### BRIEF DESCRIPTION OF THE DRAWINGS

FIG. 1 is a flow chart of a method for protecting contained anhydrous ammonia from unauthorized handling.

FIG. 2 is a schematic view of one embodiment of a general system that protects a contained form of anhydrous ammonia from unauthorized handling.

FIG. 3 is a schematic view of one embodiment of a system that protects a contained form of anhydrous ammonia from unauthorized handling, employing a chemical.

FIG. 4 is a schematic view of one embodiment of a system that protects a contained form of anhydrous ammonia from unauthorized handling, employing a mechanical device.

FIG. 5 is a schematic view of one embodiment of a system that protects a contained form of anhydrous ammonia from unauthorized handling, employing an electrical device.

### DETAILED DESCRIPTION

Generally, a protective component is described that can help interfere with unauthorized handling of a contained source of anhydrous ammonia. A method and system is described that uses the protective component to protect contained anhydrous ammonia, such as from theft or misuse. The anhydrous ammonia is contained by its absorption into a solid absorbent material. The contained anhydrous ammonia can be, for example a part of an ammonia storage and delivery system that can directly dose ammonia in the treatment of nitrogen oxide. The protective component is operatively engaged in such a way as to interfere with unauthorized handling of the anhydrous ammonia.

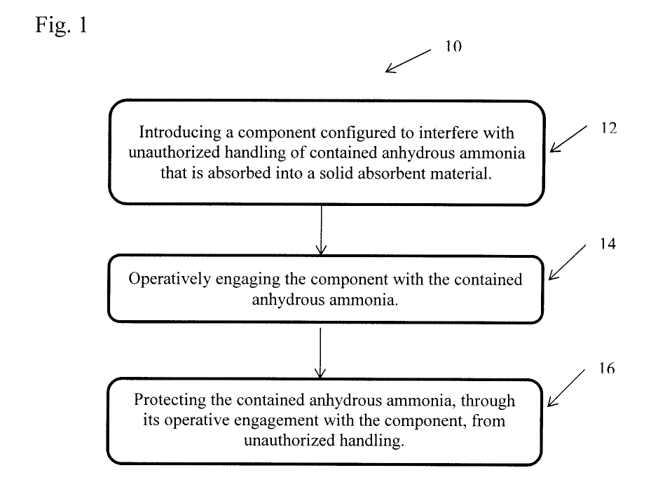

FIG. 1 is a flow chart of a method 10 for protecting contained anhydrous ammonia from unauthorized handling. The method includes introducing 12 a component configured to interfere with unauthorized handling of contained anhydrous ammonia. In one embodiment, the contained anhydrous ammonia is absorbed into a solid absorbent material. The component is operatively engaged 14 with the contained anhydrous ammonia. The contained anhydrous ammonia, through its operative engagement with the component, is protected 16 from unauthorized handling.

The term “component” herein can include but is not limited to implementations that employ one or more of a chemical, a mechanical, and an electrical approach to protect unauthorized handling of the contained anhydrous ammonia.

The terms “contained anhydrous ammonia” herein may be constructed as a storage device and/or a storage and delivery device. Some ammonia storage device and/or storage and delivery systems, such as those developed by Amminex A/S of Denmark, include the use of a solid absorbent material to store ammonia, which can release pure, anhydrous ammonia on demand. Some examples of such ammonia storage devices and ammonia storage and delivery systems can be found in U.S. Pat. No. 7,964,163 and US Patent Application Publication Nos. 2009/0123301, 2010/0024403, 2010/0086467, 2010/0266475, 2010/0047638, and 2010/0021780, all of which are incorporated by reference in their entirety. As liquid anhydrous ammonia is not safe, such as for example as on-board storage source, the approach of a solid absorbent material has been used to absorb ammonia to create for example amine salts. Generally, the salts for example are saturated or filled with ammonia and can be stored in this condition. When needed, the solid absorbent material can be heated for example to 80° C. release ammonia from the salts and be used for dosing and NOₓ treatment.

The terms “operatively engaged” or “operatively engaging” likewise can include one or more forms of a chemical reaction and/or mechanical and/or electrical interaction of the protective component with the contained anhydrous ammonia. For example, it can include but is not limited to connection either directly or indirectly of the component to the contained anhydrous ammonia. For example, certain mechanical and electrical implementations may be directly or indirectly connected with a storage device, such as a storage tank or canister, that contains the anhydrous ammonia. It can also include for example, an electrical communication, that is not directly or indirectly connected, e.g. by a wireless form of transmission from the component, such as a wireless receiver, and a storage device containing the anhydrous ammonia and a wireless transmitter coupled to the storage device. The term can also include for example, the addition of a chemical to the contained anhydrous ammonia.

To prevent theft and/or illicit use of various anhydrous ammonia storage devices, any one or more of the following proposed implementations may be employed.

In one example, a chemical may be added to the storage device. The chemical would interfere with the processes inherent to ammonia use for methamphetamine synthesis.

In another example, a chemical may be added to the storage device, the addition of which would render a final product unattractive for human consumption, such as for example having some mal-odorous or pungent species. One example of such a chemical can include the use of mercaptans.

In another embodiment, a mechanical device can be connected to the storage device. The mechanical device is configured to prevent unauthorized removal, breaching, or disconnecting of the ammonia storage system.

In another embodiment, an electrical device can be employed to prevent unauthorized removal, breaching, or disconnecting of the ammonia storage system. An electrical device can include but is not limited to an electronic alarm system. In some embodiments, an electronic tracking system may be employed, which is configured to allow tracking of the ammonia storage device if for example it is improperly moved or stolen. The electronic tracking may include a wireless transmitter associated with the ammonia storage device that emits a signal that may be used to track the ammonia storage device.

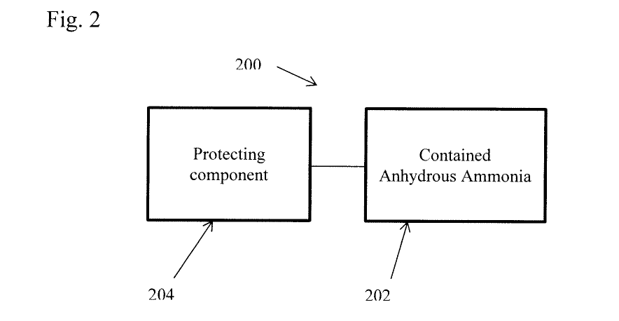

FIGS. 2-5 show general schematic representations of systems that protect a contained form of anhydrous ammonia from unauthorized handling. FIG. 2 is a schematic view showing one embodiment of a general system 200 that protects a contained form of anhydrous ammonia from unauthorized handling. The system 200 includes the contained anhydrous ammonia 202 operatively connected with a protective component 204.

FIG. 3 is a schematic view of one embodiment of a system 300 that protects a contained form of anhydrous ammonia from unauthorized handling by employing a chemical protective component 304. The system 300 includes the contained anhydrous ammonia 302 operatively connected with the chemical protective component 304. The chemical protective component 304 may be a chemical added to the contained anhydrous ammonia 302. In one embodiment, addition of the chemical may interfere with the processes inherent to ammonia use for methamphetamine synthesis. For example, any substance possessing the free radical getting ability, such as nitric oxide (NO) or disrupting the synthesis in other ways (such as H₂O) could be used for this purpose. In the cases when the interferrent cannot be admixed with NH₃ due to a detrimental effect on the normal application of the anhydrous ammonia, the chemical protective component 304 may be contained in a separate capsule. The separate capsule may be released when the container is removed or used in an unauthorized manner. In another example, the chemical protective component 304 may include a chemical that may render a final product produced after unauthorized use of the anhydrous ammonia unattractive for human consumption, such as for example chemicals having some mal-odorous or pungent species. For example, addition of small quantities (at the level of parts per million) of thiols (such as mercaptans), may impart strong unpleasant smell to the ammonia derived from the storage container. However, during the normal use of the anhydrous ammonia in a diesel emission control system, these additives may be easily destroyed by the exhaust catalytic elements. In a further example, these substances could be represented by ethane mercaptan or t-butyl mercaptan, substances commonly blended in minuscule quantities to impart unpleasant smell to natural gas.

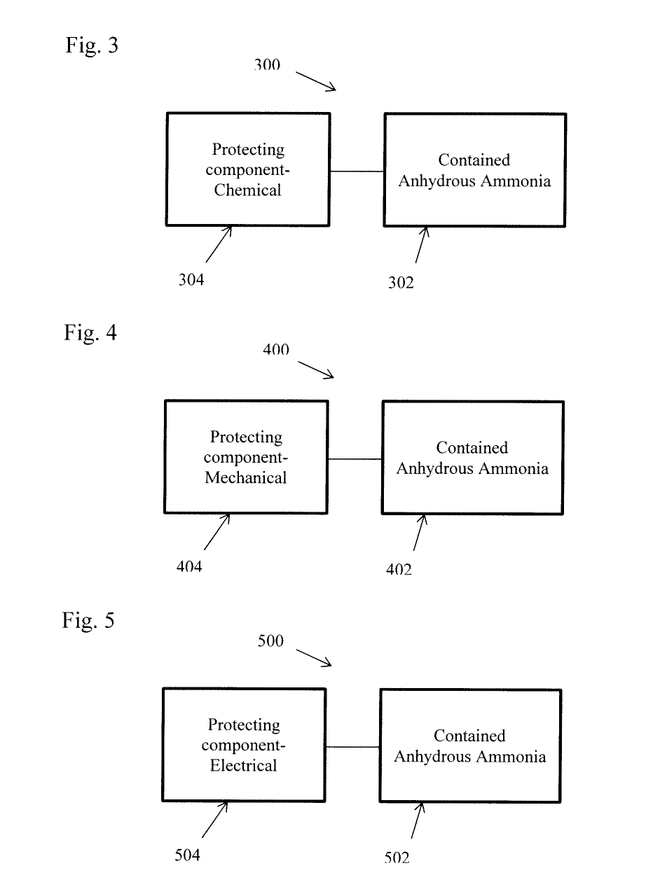

FIG. 4 is a schematic view of another embodiment of a system 400 that protects a contained form of anhydrous ammonia 402 from unauthorized handling via a mechanical protective component 404. The system 400 includes the contained anhydrous ammonia 402 operatively connected with the mechanical protective component 404, which may include the use of a mechanical device. In one embodiment, a mechanical device may include a lock for protecting the mechanically reinforced enclosure of the ammonia storage device. This lock may be opened by a vehicle key or by an additional specialized key (e.g., a key specific to the lock on the contained anhydrous ammonia 402). Another potential embodiment represents a device which, when a canister containing the contained anhydrous ammonia 402 is removed in an unauthorized manner, permanently seals the canister by deploying a trap door mechanism in the outlet passage of the canister, thus rendering it permanently inoperable. For example, a canister containing the contained anhydrous ammonia 402 may be coupled to a support structure of a vehicle. Removal of the contained anhydrous ammonia 402 from the support structure may result in a trigger releasing a trap door in the outlet passage of the canister. The trap door may be configured to seal the outlet passage when deployed therein.

FIG. 5 is a schematic view of still another embodiment of a system 500 that protects a contained form of anhydrous ammonia 502 from unauthorized handling via an electrical protective component 504. The system 500 includes the contained anhydrous ammonia 502 operatively connected with the electrical protective component 504. The electrical protective component 504 may include an electrical device, such as for example an alarm system and/or a tracking system. In one embodiment, such a device features a sensor which triggers vehicle alarm and/or alerts security or law enforcement unless some specific steps have been performed prior to the storage system removal (e.g. related to using a vehicle key to open the enclosure or providing a command to the on-board alarm system via remote alarm controller). The sensor may include a variety of sensors, including proximity sensors, magnetic sensors, RF sensors, ultrasonic sensors, optical sensors (e.g., laser trip sensor), mechanical sensors (e.g., a mechanical switch located between a canister containing the contained anhydrous ammonia 502 and a portion of the vehicle or a two-piece sensor that is triggered upon detachment), pressure sensors (e.g., via detecting a decrease in pressure of NH₃ in a supply manifold of an exhaust system), or other sensors. In some implementations, the sensors may be made tamper-proof through the use of mechanical encapsulation. In some implementations, the sensor may cause a chemical, such as those described above in reference to FIG. 3, to be released within a canister containing the contained anhydrous ammonia 502. In another embodiment, an RF-chip is incorporated into or on the contained anhydrous ammonia 502 to allow an on-board system to detect the absence of the RF-chip and trigger an alarm and/or send a signal via remote telemetry link. In other embodiments, a wireless transceiver may be incorporated into or on the contained anhydrous ammonia 502 that may be used to track the contained anhydrous ammonia 502 if it is removed via a tracking receiver, thereby forming a tracking system.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of tamper protection of a contained form of anhydrous ammonia comprising:
introducing a component configured to interfere with unauthorized handling of contained anhydrous ammonia that is absorbed into a solid absorbent material;
operatively engaging the component with the contained anhydrous ammonia; and
protecting the contained anhydrous ammonia, through its operative engagement with the component, from unauthorized handling.

2. The method of claim 1, wherein the component comprises a chemical that, when added to the anhydrous ammonia, interferes with use of the anhydrous ammonia in synthesizing methamphetamine.

3. The method of claim 1, wherein the component comprises a chemical that, when added to the anhydrous ammonia, results in a final product that is mal-odorous or pungent.

4. The method of claim 1, wherein the component comprises a mechanical device configured to interfere with removal or breach of the contained anhydrous ammonia.

5. The method of claim 1, wherein the component comprises an electronic device configured to interfere with removal or breach of the contained anhydrous ammonia.

6. The method of claim 5, wherein the electronic device comprises an alarm system.

7. The method of claim 5, wherein the electronic device comprises a tracking system.

8. A system that protects a contained form of anhydrous ammonia from unauthorized handling comprising:
a solid absorbent material;
anhydrous ammonia absorbed into the solid absorbent material; and
a component configured to interfere with unauthorized handling of the anhydrous ammonia, the component operatively engaged with the contained anhydrous ammonia.

9. The system of claim 8, wherein the component comprises a chemical that, when added to the anhydrous ammonia, interferes with use of the anhydrous ammonia in synthesizing methamphetamine.

10. The system of claim 8, wherein the component comprises a chemical that, when added to the anhydrous ammonia, results in a final product that is mal-odorous or pungent.

11. The system of claim 8, wherein the component comprises a mechanical device configured to interfere with removal or breach of the contained anhydrous ammonia.

12. The system of claim 8, wherein the component comprises an electronic device configured to interfere with removal or breach of the contained anhydrous ammonia.

13. The system of claim 12, wherein the electronic device comprises an alarm system.

14. The system of claim 12, wherein the electronic device comprises a tracking system.
